(19) United States
(12) Patent Application Publication
(10) Pub. No.: US 2012/0325067 A1
(43) Pub. Date: Dec. 27, 2012

(54) KNIFE CYLINDER, ROTARY DIE CUTTER, BLADE MOUNT, AND METHOD OF FIXING BLADE MOUNT TO KNIFE CYLINDER

(75) Inventors: Hironari Yamada, Mihara-shi (JP); Osamu Hatano, Mihara-shi (JP); Kazuya Sugimoto, Mihara-shi (JP)

(73) Assignee: Mitsubishi Heavy Industries Printing & Packaging Machinery, Ltd., Mihara-shi, Hiroshima (JP)

(21) Appl. No.: 13/510,331

(22) PCT Filed: Jan. 13, 2011
(86) PCT No.: PCT/JP2011/050471

§ 371 Date: Jun. 28, 2012

(30) Foreign Application Priority Data
Feb. 23, 2010 (JP) 2010-036879

(51) Int. Cl. B26D 7/26; B26F 1/44; B26D 1/40; B26F 1/38

(52) U.S. Cl. 83/346; 29/428; 83/698.41; 83/698.21

(57) ABSTRACT

A blade mount is brought into contact with the outer circumference face of knife cylinder such that penetrating hole having a larger diameter on the blade mount faces a stopping member of sliding member. Resilient force is generated between an active-force generator and the sliding member and thereby the stopping member is projected externally from the outer circumference face of the knife cylinder. The blade mount is slid with respect to the outer circumference face of the knife cylinder such that the inner wall of penetrating hole having a smaller diameter formed on the blade mount is fitted into the space between the outer circumference of the knife cylinder and the stopping member, so that the blade mount is fixed to the outer circumference face of the knife cylinder.

### TECHNICAL FIELD

The present invention relates to a blade mount fixed to a knife cylinder that cuts sheet-shaped articles such as corrugated board sheets and aims at shortening the time required to replace the blade mount so that the operation efficiency the rotary die cutter attaching the knife cylinder is enhanced.

### BACKGROUND

A die cut unit is disposed in the production line that manufactures a flat corrugated board sheet into a corrugated box. A die cut unit includes a rotary die cutter that punches a hole or other shapes from the corrugated board sheet. Hereinafter, description is made in relation to the overview of a rotary die cutter disclosed in Patent Literature 1 with reference to accompanying drawing FIGS. 11 and 12.

In FIG. 11, the frame of a rotary die cutter 100 includes frames 102a and 102b vertically arranged from the floor FL on the both side of the width direction of the machine; an upper stay 104 and a lower stay 106 disposed between the frames 102a and 102b and extending horizontally in the width direction of the machine; and an anvil cylinder 108 and a knife cylinder 110 are disposed horizontally in the width direction of the machine so as to sandwich the transferring path of corrugated board sheet S from the top and the bottom. The both ends of the anvil cylinder 108 and the knife cylinder 110 are pivotally supported by the frames 106a and 106b, and are rotated in opposite directions by a non-illustrated gear driving device.

A corrugated board sheet S is transferred in the direction of arrow a. At the upstream of the cylinders 108 and 110 along the transferring direction, forwarding rolls 112a and 112b are disposed so as to sandwich the transferring path and cooperatively transfer a corrugated board sheet S between the cylinders. A blade mount 114 normally made of wood is attached to the outer circumference face of the knife cylinder 110. The blade mount 114 includes a punching blade such as a cutting knife 116, a creaser knife or the like.

After undergoing printing, slotting, and ruled-line formation in previous process, the corrugated board sheets S are punched by, for example, the cutting knife 116 or the creaser knife while passing through between the anvil cylinder 108 and the knife cylinder 110.

Next, description will now be made in relation to the configuration of the blade mount 114 and the manner of mounting the blade mount 114 to the outer circumference face of the knife cylinder with reference to FIG. 12. The knife cylinder 110 of FIG. 11 includes a large number of screw holes 118 formed at a regular pitch almost the entire outer circumference face of the knife cylinder 110. Two fixing rings 120a and 120b are mounted onto the both end of the knife cylinder 110 so as to be movable along the axis of the knife cylinder 110.

The blade mount 114 is mounted onto the knife cylinder 110 through bringing the blade mount 114 in contact with the outer circumference face of the knife cylinder 110 and determining the position of the blade mount 114 with respect to the knife cylinder 110. Keeping this position, the fixing rings 120a and 120b are brought close to the blade mount 114 from the both ends of the knife cylinder 110. The blade mount 114 has slope faces at the both ends of the axis direction and the both ends of the circumference direction, and the slope faces are depressed by the fixing rings 120a and 120b. With this arrangement, bolts 122 are screwed into screw holes 118, so that the fixing rings 120a and 120b are fixed.

The end faces of the blade mount 114 along the circumference direction of the knife cylinder 110 is depressed by a metal patch 124, which is fixed by bolts 126. In order to prevent the center position of the blade mount 114 from rising up from the outer circumference of the knife cylinder, flush bolts 128 are inserted into a number of penetrating holes formed on the blade mount 114 and are screwed into the screw holes 118. Thereby the blade mount 114 can be prevented from rising up.

There are also used stripping pins that remove off cutting chips of the corrugated board sheet S clogging the cutting knife 116 after the corrugated board sheet undergoes the punching process. The stripping pins are disposed one at every two screw holes 118. Therefore, the screw holes 118 are used for the bolt to fix the blade mount and the stripping pins.

### PRIOR ART REFERENCES

### Patent Literature

[Patent Literature 1] Japanese Patent Laid-open Publication No. HEI 8-229885

### SUMMARY OF INVENTION

### Problems to be Solved by Invention

As described above, when the blade mount 114 is mounted on the outer circumference face of the knife cylinder, the blade mount 114 is prevented from rising by a large number of flush bolts 128 depressing the blade mount 114. This manner needs to remove and reinstall many flush bolts 128 when the blade mount 114 is replaced and therefore takes a long time.

For example, FIG. 7(B) denotes the time that a single operator requires to replace a wooden frame (i.e., blade mount) using 26 anti-rising bolts and 31 stripping pins. In this example, it takes a long time to attach and remove the anti-rising pins and the striping pins, and it took 9 minutes and 30 seconds in total to replace the mount including 4 minutes and 20 seconds for removing and installing bolts. This causes a problem of requiring a long time to set up the rotary die cutter in response to order change, lowering operation efficiency of the device.

The devices constituting the casemaker line are arranged on a rail and are slidable in the line direction. The open and close of the die cut unit in the drawing represent operation that moves unit adjacent to the die cut unit to make a space between the units so that the blade mount can be replaced.

With the foregoing problems in view, the object of the present invention to shorten the time required for replacing a blade mount to be fixed on the knife cylinder, so that the operation efficiency of the rotary die cutter is improved.

### Means to Solve the Problem

To attain the above object, the present invention provides a method of fixing a blade mount to a knife cylinder that faces an anvil cylinder, that has a cylindrical outer circumference face holding the blade mount, and that cuts a sheet-shape article placed into a space between the anvil cylinder and the knife cylinder, the method including: preparing the knife cylinder having: a fixing hole opening to the outer circumference face; an active-force generator arranged inside the fixing hole; a sliding member that is freely fitted into the fixing hole and that selectively exerts attracting or resilient force on the active-force generator; and a stopping member that is integrated with the sliding member and that is disposed so as to face the opening of the fixing hole, and the blade mount having a first penetrating hole and a second penetrating hole connected to each other and having different opening diameters, bringing the blade mount into contact with the outer circumference face of the knife cylinder such that the first penetrating hole having a larger diameter on the blade mount faces the stopping member of the sliding member; generating resilient force between the active-force generator and the sliding member and thereby projecting the stopping member externally from the outer circumference face of the knife cylinder; and sliding the blade mount with respect to the outer circumference face of the knife cylinder such that the inner wall of the second penetrating hole having a smaller diameter formed on the blade mount is fitted into the space between the outer circumference of the knife cylinder and the stopping member, so that the blade mount is fixed to the outer circumference face of the knife cylinder.

There is provided at least one fixing hole at a position not obstructing a blade of the blade mount. If two or more fixing holes are to be formed, the holes are appropriated distributed over the outer circumference face of the knife cylinder. A fixing hole not used for preventing the blade mount from rising generates attracting force between the active-force generator and the sliding member, so that the stopping member is evacuated inside the fixing hole so as not obstruct the blade mount.

A fixing hole used for preventing the blade mount from rising generates resilient force between the active-force generator and the sliding member, so that the stopping member outwardly projects from the fixing hole. This switching can be accomplished in a single step through the use of a jig, largely reducing the time required for attaching and detaching the blade mount as compared with a conventional manner.

The method may further include embedding magnets into at least part of facing surfaces of the active-force generator and the sliding member, the facing surfaces facing each other, to form magnetic regions, the generating may cause the magnetic regions having the same polar of the active-force generator and the sliding member to face each other and thereby generates the resilient force, and when the sliding member does not fix the blade mount, and attractive force may be generated between the active-force generator and the sliding member by causing the magnetic regions having different in polar to face each other or by causing one of the magnetic regions and a magnetic body region to face each, so that the stopping member of the sliding member is placed under the outer circumference face of the knife cylinder.

A magnetic body region is formed of a substance that has magnetism and can be attracted by a magnet. An example of the substance is iron, which has a ferromagnetic property.

In the above manner, the stopping member, which is integrated with a sliding member, is projected from the outer circumference face of the knife cylinder and is placed under the outer circumference face using the resilient force generated between regions the same in polar and the attracting force generated between regions opposite in polar or between a magnetic region and a magnetic body region. With this simple configuration using magnets, the blade mount can be attached and detached without requiring an additional power source.

The method may further includes embedding N-polar magnets into part of the facing surfaces of the active-force generator and the sliding member to form N-polar magnetic regions and embedding S-polar magnets into other part of facing surfaces of the active-force generator and the sliding member to form S-polar magnetic regions; the generating may cause the magnetic regions having the same polar of the active-force generator to face each other and the sliding member and thereby generates the resilient force, and, when the sliding member does not fix the blade mount, attractive force may be generated between the active-force generator and the sliding member by causing the magnetic regions having different in polar to face each other, so that the stopping member of the sliding member is placed under the outer circumference face of the knife cylinder.

This simple configuration using the resilient force generated between regions the same in polar and the attracting force generated between regions opposite in polar surely moves the stopping member upward and downward.

Alternatively, the method may further include embedding magnets the same in polar into at least part of facing surfaces of the active-force generator and the sliding member, the facing surfaces face each other, to form magnetic regions, and forming magnetic metal regions on different parts of the facing surfaces of the active-force generator and the sliding member, the generating may cause the magnetic regions of the active-force generator and the sliding member to face each other and thereby generates the resilient force, and, when the blade mount is not being fixed, attractive force may be generated between the active-force generator and the sliding member by causing each respective magnetic regions and each magnetic body region to face each other, so that the stopping member of the sliding member is placed under the outer circumference face of the knife cylinder.

This method uses the resilient force generated between regions the same in polar and the attracting force generated between a magnetic region and a magnetic metal region further simplify the entire configuration, concurrently reducing the cost.

The present invention provides a knife cylinder that faces an anvil cylinder and that has cylindrical outer circumference face that holds the blade mount, and that cuts a sheet-shape article placed into a space between the anvil cylinder and the knife cylinder, the knife cylinder comprising: a fixing hole opening to the outer circumference face; an active-force generator arranged inside the fixing hole; a sliding member that is freely fitted into the fixing hole and that selectively exerts attracting or resilient force on the active-force generator; and a stopping member that is integrated with the sliding member and that is projected outwardly from the outer circumference face of the knife cylinder when the resilient force is exerted between the sliding member and the active-force generator, wherein the inner wall of a penetrating hole formed on the blade mount is fitted into the space between the outer circumference of the knife cylinder and the stopping member, so that the blade mount is fixed to the outer circumference face of the knife cylinder.

The above configuration causes the sliding member, which fixes the blade mount, to generate the resilient force together with the active-force generator, so that the stopping member projects outward from the outer circumference of the knife cylinder. When the sliding member does not fix the blade mount, the sliding member generates the attracting force to evacuate the stopping member under the outer circumference face of the knife cylinder, so that the stopping member does not obstruct the blade mount. This switching can be accomplished in a single step, largely reducing the time required for attaching and detaching a blade mount as compared with a conventional manner.

The knife cylinder may further include magnetic regions formed on at least part of facing surfaces of the active-force generator and the sliding member, the facing surface facing each other, by embedding magnets, wherein the sliding member is rotatable around the axis thereof, resilient force may be generated between the active-force generator and the sliding member by causing the magnetic regions the same in polar of the active-force generator and the sliding member to face each other while attracting force may be generated between the active-force generator and the sliding member by causing the magnetic regions opposite in polar of the active-force generator and the sliding member to face each other.

In the above manner, the stopping member, which is integrated with a sliding member, is projected from the outer circumference face of the knife cylinder and is placed under the outer circumference face using the resilient force generated between regions the same in polar and the attracting force generated between regions opposite in polar or between a magnetic region and a magnetic body region. It is possible to switch between the resilient force and the attracting force simply by rotating the sliding member. With this simple configuration using magnets, the blade mount can be attached and detached without requiring an additional power source.

Alternatively, in the knife cylinder of the present invention, the active-force generator and the sliding member may each include an N-polar magnetic region formed by embedding an N-polar magnet on a first region of the facing surface and an S-polar magnetic region formed by embedding an S-polar magnet on a second region of the facing surface; the sliding member may be rotatable around the axis thereof, and resilient force may be generated between the active-force generator and the sliding member by causing the magnetic regions the same in polar of the active-force generator and the sliding member to face each other while attracting force may be generated between the active-force generator and the sliding member by causing the magnetic regions opposite in polar of the active-force generator and the sliding member to face each other.

This simple configuration using the resilient force generated between regions the same in polar and the attracting force generated between regions opposite in polar surely moves the stopping member upward and downward.

Further alternatively, the active-force generator and the sliding member may each include a magnetic region formed by embedding a magnet same in polar in part of the facing surface and a magnetic metal region on different part of the facing surface; the sliding member may be rotatable around the axis thereof; resilient force may be generated between the active-force generator and the sliding member by causing the magnetic regions of the active-force generator and the sliding member to face each other while attracting force may be generated between the active-force generator and the sliding member by causing the respective magnetic regions of the active-force generator and the sliding member to face the respective magnetic metal regions, so that the stopping member of the sliding member is placed under the outer circumference face of the knife cylinder.

This configuration uses the resilient force generated between regions the same in polar and the attracting force generated between a magnetic region and a magnetic metal region further simplify the entire configuration, concurrently reducing the cost.

The knife cylinder of the present invention may further include a spring member that is disposed between the active-force generator and the sliding member and that generates auxiliary urging force to the resilient force between the active-force generator and the sliding member.

With the aid of the spring force generated by the spring member, the stopping member integrated with the sliding member can be surely projected outward from the fixing hole, which makes it possible to surly fix the blade mount.

The present invention provides a rotary die cutter including an anvil cylinder and a knife cylinder facing each other, the knife cylinder having an outer circumference face holding a blade mount, the rotary die cutter inserting a sheet-shaped article between the anvil cylinder and the knife cylinder and cutting the sheet-shaped article, wherein: the knife cylinder has the above configuration; and the inner wall of a penetrating hole formed on the blade mount is fitted into a space between the outer circumference face of the knife cylinder and the stopping member so that the blade mount is fixed to the outer circumference face of the knife cylinder.

The rotary die cutter of the present invention makes it possible with the above configuration to largely reduce the time to attach and detach the blade mount to the knife cylinder as compared with a conventional manner, and the blade mount can be surely fixed to the knife cylinder.

The present invention provides a blade mount that is fixed to the outer circumference face of a knife cylinder disposed facing an anvil cylinder and that cuts a sheet-shaped article placed between an anvil cylinder and the knife cylinder, the blade mount including: a first penetrating hole having a larger diameter than that of a stopping member projecting from the outer circumference face of the knife cylinder and a second penetrating hole having a smaller diameter than that of the stopping member, the first penetrating hole being connected to the second penetrating hole, wherein the blade mount is brought into contact with the outer circumference face of the knife cylinder to allow the stopping member to be inserted and placed into the first penetrating hole, and the inner wall of the second penetrating hole is fitted into and fixed to the space between the stopping member and the outer circumference face of the knife cylinder.

The blade mount of the present invention is attached to the outer circumference face of the knife cylinder by the stopping member, and therefore does not necessitate a large number of bolts as required in a conventional manner. This facilitates attaching and detaching, taking a short time. The shapes of the first and the second penetrating holes should by no means be limited to circles and may alternatively be ellipses or polygons.

In the blade mount of the present invention, the inner wall of the second wall may be a slope wall having a slope face widening toward the outer face, and the slope wall may be fitted into and fixed to the space between the stopping member and the outer circumference face of the knife cylinder. This further facilitates attaching the blade mount, and concurrently the retention force of the blade mount can be kept to be high.

### Effect of Invention

The method of the present invention relates to fixing a blade mount to a knife cylinder that faces an anvil cylinder, that has a cylindrical outer circumference face holding the blade mount, and that cuts a sheet-shape article placed into a space between the anvil cylinder and the knife cylinder, the method including: preparing the knife cylinder having: a fixing hole opening to the outer circumference face; an active-force generator arranged inside the fixing hole; a sliding member that is freely fitted into the fixing hole and that selectively exerts attracting or resilient force on the active-force generator; and a stopping member that is integrated with the sliding member and that is disposed so as to face the opening of the fixing hole, and the blade mount having a first penetrating hole and a second penetrating hole connected to each other and having different opening diameters, bringing the blade mount into contact with the outer circumference face of the knife cylinder such that the first penetrating hole having a larger diameter on the blade mount faces the stopping member of the sliding member; generating resilient force between the active-force generator and the sliding member and thereby projecting the stopping member externally from the outer circumference face of the knife cylinder; and sliding the blade mount with respect to the outer circumference face of the knife cylinder such that the inner wall of the second penetrating hole formed on a blade mount having a smaller diameter is fitted into the space between the outer circumference of the knife cylinder and the stopping member, so that the blade mount is fixed to the outer circumference face of the knife cylinder. Thereby, it is possible to largely reduce time required to replace the blade mount as compared with a conventional manner, improving the operation efficiency in a rotary die cutter or a casemaker equipped with this knife cylinder.

The knife cylinder of the present invention relates to one that faces an anvil cylinder and that has cylindrical outer circumference face that holds the blade mount, and that cuts a sheet-shape article placed into a space between the anvil cylinder and the knife cylinder, the knife cylinder including: a fixing hole opening to the outer circumference face; an active-force generator arranged inside the fixing hole; a sliding member that is freely fitted into the fixing hole and that selectively exerts attracting or resilient force on the active-force generator; and a stopping member that is integrated with the sliding member and that is projected outwardly from the outer circumference face of the knife cylinder when the resilient force is exerted between the sliding member and the active-force generator, wherein the inner wall of a penetrating hole formed on the blade mount is fitted into the space between the outer circumference of the knife cylinder and the stopping member, so that the blade mount is fixed to the outer circumference face of the knife cylinder. Thereby, it is possible to largely reduce time required to replace the blade mount as compared with a conventional manner, improving the operation efficiency in a rotary die cutter equipped with this knife cylinder of the present invention.

The rotary die cutter of the present invention includes an anvil cylinder and a knife cylinder facing each other, the knife cylinder having an outer circumference face holding a blade mount, the rotary die cutter inserting a sheet-shaped article between the anvil cylinder and the knife cylinder and cutting the sheet-shaped article, wherein: the knife cylinder has the above configuration; and the inner wall of a penetrating hole formed on the blade mount is fitted into a space between the outer circumference face of the knife cylinder and the stopping member so that the blade mount is fixed to the outer circumference face of the knife cylinder. Thereby, it is possible to largely reduce time required to replace the blade mount as compared with a conventional manner, improving the operation efficiency in the rotary die cutter.

The blade mount of the present invention relates to one that is fixed to the outer circumference face of a knife cylinder disposed facing an anvil cylinder and that cuts a sheet-shaped article placed between an anvil cylinder and the knife cylinder, the blade mount including: a first penetrating hole having a larger diameter than that of a stopping member projecting from the outer circumference face of the knife cylinder and a second penetrating hole having a smaller diameter than that of the stopping member, the first penetrating hole being connected to the second penetrating hole, wherein the blade mount is brought into contact with the outer circumference face of the knife cylinder to allow the stopping member to be inserted and placed into the first penetrating hole, and the inner wall of the second penetrating hole is fitted into and fixed to the space between the stopping member and the outer circumference face of the knife cylinder. Thereby, it is possible to largely reduce time required to replace the blade mount as compared with a conventional manner, improving the operation efficiency in the rotary die cutter equipped with the knife cylinder.

### BRIEF DESCRIPTION OF DRAWING

FIG. 1 A sectional view of a knife cylinder of a method and a device according to the first embodiment of the present invention;

FIG. 2 A sectional view of the A-A line of FIG. 1;

FIG. 3 A sectional view of the B-B line of FIG. 1;

FIG. 4 A perspective view of a blade mount according to the first embodiment;

FIG. 5 A sectional view of a knife cylinder during the operation of a fixing unit according to the first embodiment;

FIG. 6 A sectional view of a knife cylinder when a fixing unit fixes a blade mount in the first embodiment;

FIG. 7 (A) being a diagram denoting the time required for replacement of a blade mount in the present invention, and (B) being a diagram denoting the time required for replacement of a blade mount in a conventional manner;

FIG. 8 A sectional view, corresponding to FIG. 2, of a method and a device according to a second embodiment of the present invention;

FIG. 9 A sectional view, corresponding to FIG. 3, of a method and a device according to a second embodiment of the present invention;

FIG. 10 A sectional view of a knife cylinder of a method and a device according to a third embodiment of the present invention;

FIG. 11 A cross sectional view of a rotary die cutter; and

FIG. 12 A perspective view of a knife cylinder carrying a blade mount attached in a conventional manner.

### EMBODIMENT TO CARRY OUT INVENTION

Hereinafter, the present invention will now be detailed with reference to the accompanying drawings illustrating various embodiments. However, dimension, material, shape, and relative position of the components described in embodiments should by no means be limited to those of the description unless specified.

### First Embodiment

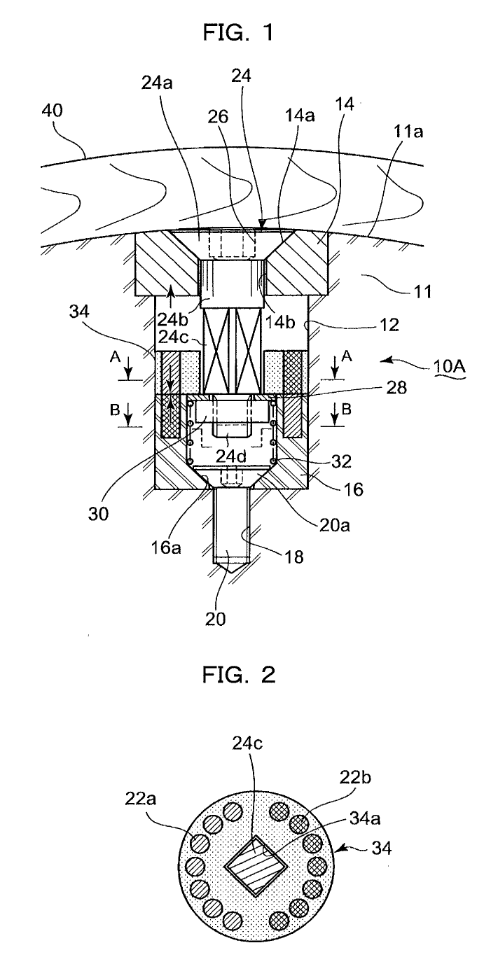

Description will now be made in relation to a method and a device according to the first embodiment of the present invention applied to a die cutting unit of a corrugated-board casemaker with reference to FIGS. 1-7. First of all, the configuration of a knife cylinder of the first embodiment will be described with reference to FIGS. 1-3. As illustrated in FIG. 1, a fixing hole 12 is formed on the outer circumference face 11a of the knife cylinder 11, and the fixing hole 12 has an opening on the outer circumference face 11a and extends toward the center of the knife cylinder 11. A number of fixing holes 12 are provided at a substantially regular pitch in the axis and circumference directions of the knife cylinder 11 except for the center region of the outer circumference face 10a (sic) where the blade of a blade mount 40 detailed below is to be arranged.

A circular base 14 is fitted and fixed to the level difference formed at the opening of the fixing hole 12. A penetrating hole formed in the center of the base 14 has a cone-shape slope face 14a that becomes wider toward the top at the upper portion, and a cylindrical face 14b having a uniform inner diameter at the lower portion. A metallic magnetic-force generator 16 is placed inside the fixing hole 12. The magnetic-force generator 16 has a hollow center portion and has a cone-shape slope face 16a projecting toward the center. A screw hole 18 is formed on the bottom of the fixing hole 12 and a flush bolt 20 is screwed into the screw hole 18. The top 20a of the flush bolt 20 catches the slope face 16a and fixes the magnetic-force generator 16 to the bottom of the fixing hole 12.

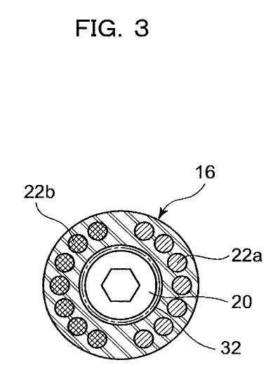

As illustrated in FIG. 3, a number of cylindrical magnets are embedded in arcs on the top surface of magnetic-force generator 16. An N-pole magnetic region consisting of embedded N-pole magnets 22a is formed on the right top surface while an S-pole magnetic region consisting of embedded S-pole magnets 22b is formed on the left top surface.

A metal sliding member 24 is inserted and placed through the cylindrical face 14b of the base 14 into the hole 12. The sliding member 24 includes, from the top, a cone-shape flush portion 24a, a cylindrical portion 24b, a stem 24c having a square cross section, and a screw portion 24d. The flush portion 24a has a hexagon hole 26 on the top to receive the tip of a hexagonal axis 54 of a driver tool 50 to be detailed below.

A nut 30 is screwed into the screw portion 24d via a washer 28. A coil spring 32 is placed inside an internal space of the magnetic-force generator 16 and exerts spring force that upwardly urges the washer 28. A circular magnetic-force generator 34 is placed in a space over the magnetic-force generator 16 so as to enclose the stem 24c. The magnetic-force generator 34 has a square hole 34a at the center of the bottom. The stem 24c freely fitted into the hole 34a, so that the stem 24c is not fixed to any portion and freely slides in the hole 12.

As illustrated in FIG. 2, a number of magnets having the same shapes as those of the magnets 22a and 22b embedded in the magnetic-force generator 16 are embedded in the magnetic-force generator 34 in arcs. The magnetic-force generator 34 has an S-pole magnetic region consisting of embedded S-pole magnets 22b at a position facing the N-pole magnets 22a embedded in the magnetic-force generator 16 and also has an N-pole magnetic region consisting of embedded N-pole magnets 22a at a position facing the S-pole magnets 22b embedded in the magnetic-force generator 16. The parts and elements described above constitute a blade-mount fixing unit 10A.

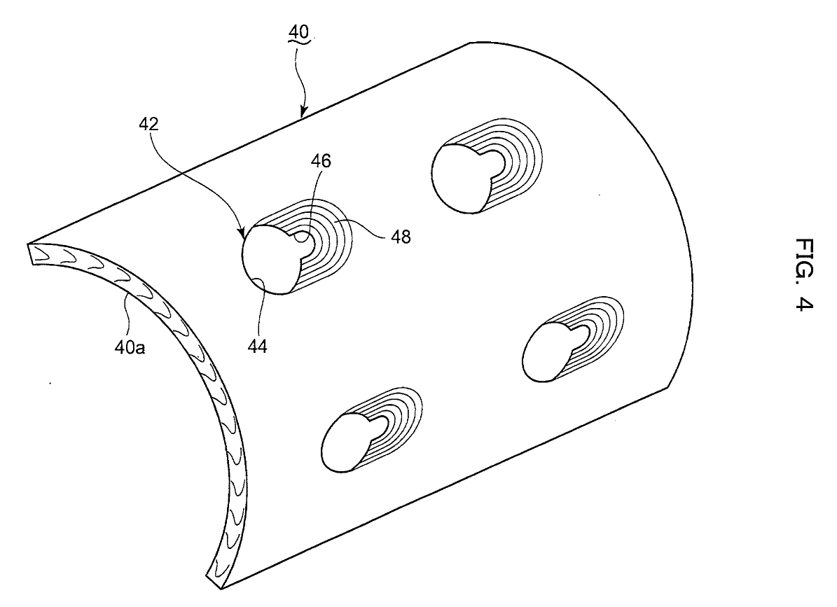

Next, description will now be made in relation to the configuration of a wooden blade mount 40 used in the first embodiment with reference to FIG. 4. In FIG. 4, the blade mount 40 has an inner circumference face 40a having the same curvature as that of the outer circumference face 11a, so that the entire inner circumference face 40a can be brought into intimate contact with the outer circumference face 11a. The blade mount 40 includes four top-joint penetrating holes 42 symmetrically with respect to the center of the blade mount 40. Each penetrating hole 42 has a large diameter portion 44 and a small diameter portion 46 that are connected to each other. The large diameter portion 44 has a vertical wall while the small diameter portion 46 has a slope face 48 widening toward the outside.

The slope face 48 has the same tilt angle as that of the slope face of the flush portion 24a of the sliding member 24, so that the slope face 48 is neatly fitted to the flush portion 24a. The diameter of the large diameter portion 44 is set to be larger than the maximum diameter of the flush portion 24a while the minimum diameter of the small diameter portion 46 is set to be smaller than the maximum diameter of the flush portion 24a. The large diameter portion 44 and the small diameter portion 46 are arranged in the axis direction of the knife cylinder 11.

The shapes of the large diameter portion 44 and the small diameter portion 46 should by no means be limited to circles, and may alternatively be ellipses or polygons.

As illustrated in FIG. 1, when the blade mount 40 is not mounted on the outer circumference face 11a of the knife cylinder or the blade mount 40 is mounted on the outer circumference face 11a of the knife cylinder but is not fixed in the blade-mount fixing unit 10A, the flush portion 24a is flush with the outer circumference face 11a of the knife cylinder or downwardly evacuates from the outer circumference face 11a of the knife cylinder. With this configuration, the S-pole magnetic region formed of the embedded the S-pole magnets 22b of the magnetic-force generator 16 faces the N-pole magnetic region formed of the embedded N-pole magnets 22a of the magnetic-force generator 34. Thereby, the S-pole magnets 22b and the N-pole magnets 22a attract each other, so that the magnetic-force generator 16 falls to come into contact with the other magnetic-force generator.

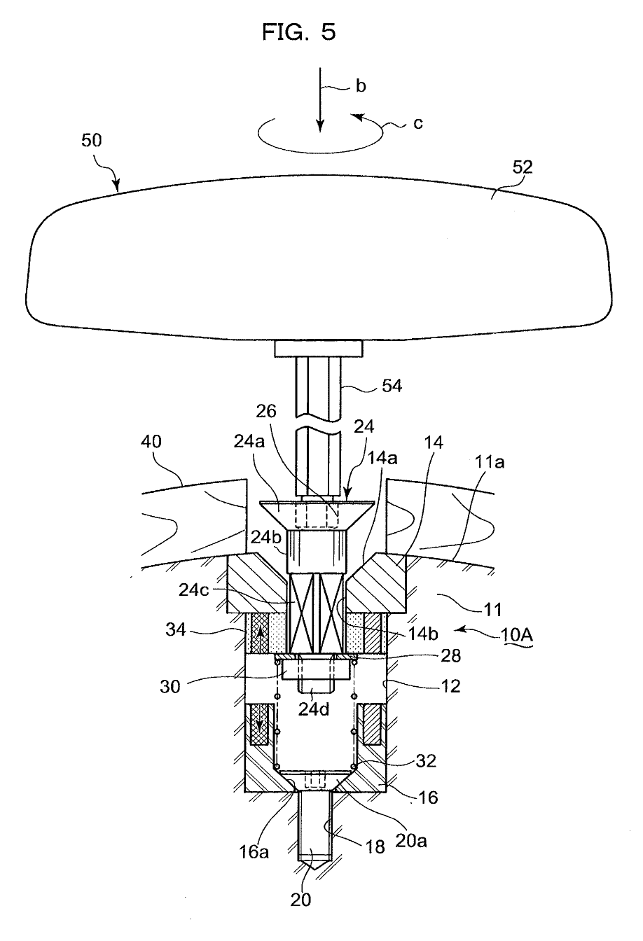

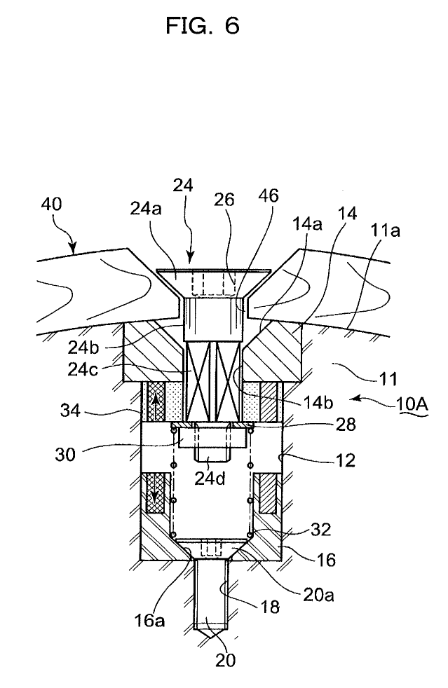

Description will now be made in relation to a procedure to fix the blade mount 40 being in the sate of FIG. 1 through the use of the fixing unit 10A with reference to FIGS. 5 and 6. The blade mount 40 is positioned on the outer circumference face 11a of the knife cylinder 11. In this positioning, as depicted in FIG. 5, the large diameter portion 44 of the blade mount 40 comes to face the flush portion 24a.

Then, the sliding member 24 is turned 180 degrees using the driver tool 50. The driver tool 50 has a handle 52 and the hexagonal axis 54 attached to the handle 52. The operator holds the handle 52 and turns the handle 52 in the direction b, so that the hexagonal axis 54 is inserted into the hexagon hole 26 formed on the flush portion 24a. Placing the handle 52 in the hexagon hole 26, the handle 52 is turned in the direction c so that the sliding member 24 is turned 180 degrees. Thereby the magnetic-force generator 34, which is freely fitted to the stem 24c of the sliding member 24, turns 180 degrees.

Upon the magnetic-force generator 34 turns 180 degrees, the N-pole magnetic regions of the magnetic-force generators 16 and 34 face each other and the S-pole magnetic regions of the magnetic-force generators 16 and 34 also face each other to generate resilient force. The sum of the resilient force and the spring force of the coil spring 32 concurrently raises the magnetic-force generator 34 and the sliding member 24. Then, as illustrated in FIG. 6, the magnetic-force generator 34 touches the bottom face of the base 14 to stop the magnetic-force generator 34 and the sliding member 24. This causes the flush portion 24a to project from the outer circumference face 11a of the knife cylinder.

Alternatively, the blade mount 40 may be then positioned on the outer circumference face 11a of the knife cylinder 11.

Next, as depicted in FIG. 6, the blade mount 40 is moved along the axis direction of the knife cylinder 11, so that the slope face 48 is fitted into the space between the flush portion 24a and the outer circumference face 11a of the knife cylinder. Thereby, the blade mount 40 is fixed to the flush portion 24a. The above fixing procedure is carried out on the four penetrating holes 42 formed on the blade mount 40.

The blade mount 40 can be removed through the opposite procedure to the above mounting procedure. Specifically, the blade mount 40 being in the state of FIG. 6 is moved in the axis direction of the knife cylinder and the slope face 48 is slid from the space between the flush portion 24a and the outer circumference face 11a of the knife cylinder, so that the blade mount 40 is brought into a state of FIG. 5.

Then the operator turns the sliding member 24 180 degrees through the use of the driver tool 50. Thereby, N-pole magnets 22a in the magnetic-force generators 16 and 34 face the S-pole magnets 22b in the magnetic-force generators 34 and 16 to generate attracting force between the magnetic-force generators 16 and 34, so that the magnetic-force generator 34 and sliding member 24 fall such that the flush portion 24a is flush with the outer circumference face 11a of the knife cylinder.

As the above, the center portion of the blade mount 40 can be avoided from rising by the fixing unit 10A. Besides, the both ends of the blade mount 40 on the axis direction of the knife cylinder 11 are fixed by fixing rings 120a and 120b in any conventional manner. Consequently, the blade mount can be fixed.

The first embodiment can largely reduce time required for mounting and removing the blade mount 40 as compared with any conventional manner because, after the blade mount 40 is positioned on the outer circumference face 11a of the knife cylinder, the operator simply makes a 180-degree turn through the use of the driver tool 50 and the slope face 48 of the blade mount 40 is thereby fitted and fixed to the flush portion 24a. Therefore, operation of the die cut unit can be prolonged for the reduced time, so that operation efficiency of the casemaker can be enhanced.

The first embodiment uses the attracting force and the resilient force between magnets not for fixing the blade mount 40 but only for raising the sliding member 24. The blade mount 40 is fixed by fitting the blade mount 40 between the flush portion 24a positioning at the risen position and the outer circumference face 11a of the knife cylinder and applying tightening force exerting between the flush portion 24a and the outer circumference face 11a of the knife cylinder to the blade mount 40. This can keep the retention force of the blade mount 40 to be high.

In addition, the first embodiment arranges the large diameter portion 44 and the small diameter portion 46 of each penetrating hole 42 in the axis direction of the knife cylinder. This configuration allows the blade mount 40 to be attached to and removed from the knife cylinder 11 simply by sliding along the axis direction of the knife cylinder.

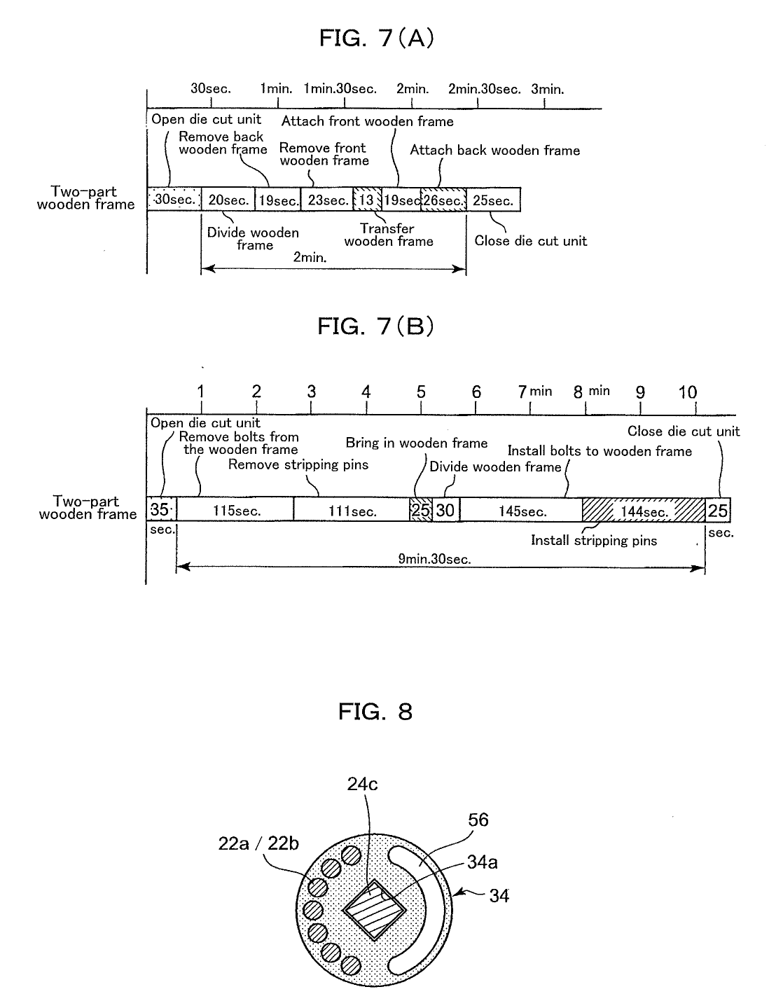

FIG. 7(A) shows an example of time required for replacement of a blade mount actually carried out in the manner according to the first embodiment. In this example, the blade mount took a form of a two-part wooden frame; a single operator independently carried out the replacement; and a wooden frame (blade mount) was fixed to a knife cylinder 11 including the fixing unit 10A of the outer circumference face without using bolts as used in conventional manners.

Since the two-part wooden blade mount is attached to the substantially entire circumference of the knife cylinder along the circumference direction, when one of the two parts is to be attached, the knife cylinder needs to rotate a half turn. For the above, it takes longer time to attach such a two-part blade mount than a single-part blade mount.

However, the device and the manner of the first embodiment required only two minutes to replace two-part blade mount, which is much shorter than the conventional manners using bolts.

The above first embodiment divides the contacting surfaces of the magnetic-force generators 16 and 34, facing the contacting surface of the other generators, are each divided into two sections at 180 degrees to serve as an N-polar magnetic region formed of embedded N-pole magnet 22a and an S-polar magnetic region formed of embedded S-pole magnet 22b.

Alternatively, each contacting surface of the magnetic-force generators 16 and 34 may be divided into four sections at 90 degrees and N-polar magnets and S-polar magnets may be alternately embedded in the four sections.

This configuration makes it possible to switch between the attracting force and the resilient force applied to between the magnetic-force generators 16 and 34 simply by turning the magnetic-force generator 34 90 degrees. This can further reduce the time for switching, more facilitating the replacement of a blade mount 40.

### Second Embodiment

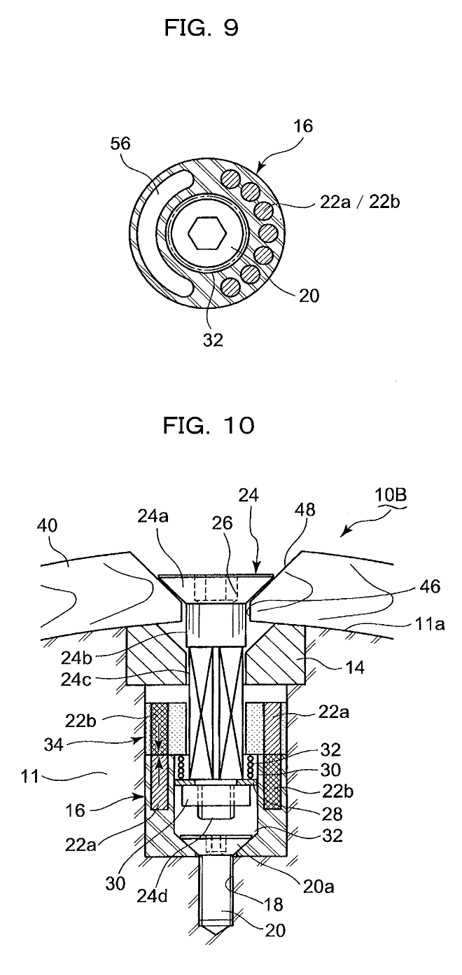

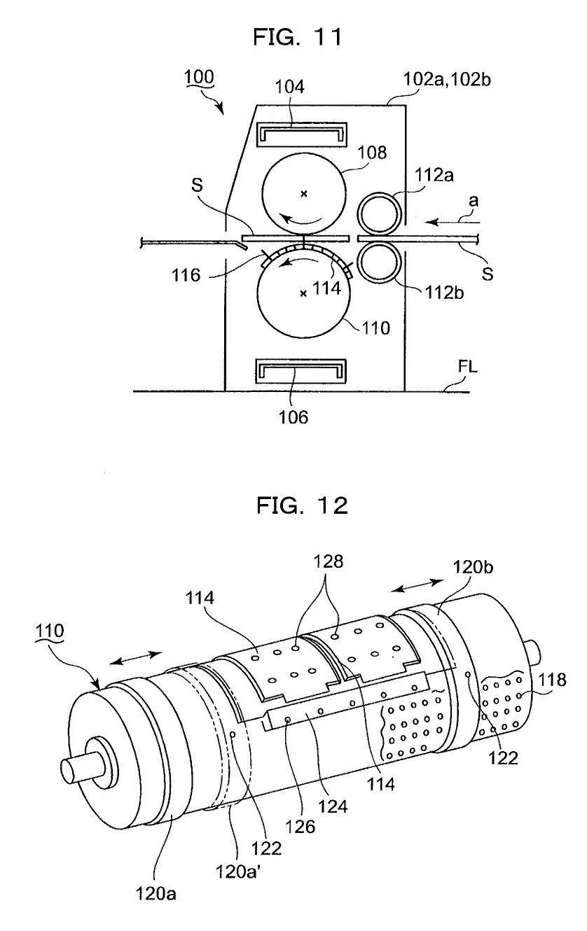

Next description will now be made in relation to the method and the device according to the second embodiment of the present invention with reference to FIGS. 8 and 9. FIG. 8 is a sectional view corresponding to FIG. 2 of the first embodiment; and FIG. 9 is a sectional view corresponding to FIG. 3.

In the second embodiment, the magnetic-force generators 16 and 34 include magnetic regions formed by embedding magnets (N-polar magnets 22a or S-polar magnets 22b) having the same polar on the half regions of the respective contacting surface, and also include magnetic metal regions 56 formed of magnetic metal on the other half regions. The magnetic metal region 56 is preferably made of ferromagnetic metal such as steel.

This configuration exerts resilient force between the magnetic-force generators 16 and 34 when the magnetic region having the same polar caused by magnets having the same polar embedded in the region to face each other. A 180-degree turn of the magnetic-force generator 34 with the driver tool 50 causes the magnetic regions of the magnetic-force generators 16 and 34 to face the respective magnetic metal region 56 of the other magnetic-force generators 16 and 34, so that attractive force is generated between the magnetic-force generators 16 and 34. Alternatively, the magnetic-force generators 16 and 34 may be made of magnetic metal, which substitutes for the magnetic metal regions 56.

### Third Embodiment

Next, description will now be made in relation to the method and the device according to the third embodiment with reference to FIG. 10. A fixing unit 10B of the third embodiment includes a coil spring 32 between the magnetic-force generator 34 and the washer 28 and the remaining configuration the same as the above first embodiment.

In the third embodiment, when the blade mount 40 is to be sandwiched and fixed between the flush portion 24a of the sliding member 24 and the outer circumference face 11a of the knife cylinder, attracting force is generated between the magnetic-force generators 16 and 34 by causing the magnets of a magnetic-force generator 16 and the magnets having a different polar of magnetic-force generator 34 to face each other. In addition to the attracting force, the spring force of the coil spring 32 is applied in a direction to drop the sliding member 24. The sum of the attracting force and the spring force of the coil spring 32 applies tightening force to fix the flush portion 24, being caught by the slope face 48 of the blade mount 40. Therefore, the retention force of the blade mount 40 can be held by larger force, and consequently held more stably.

### INDUSTRIAL APPLICABILITY

According to the present invention, it is possible to reduce time for replacing a blade mount of a die cut unit applied to, for example, a casemaker that fabricates a corrugated board boxes, so that the operation efficiency of the casemaker can be enhanced.

1. A method of fixing a blade mount to a knife cylinder that faces an anvil cylinder, that has a cylindrical outer circumference face holding the blade mount, and that cuts a sheet-shape article placed into a space between the anvil cylinder and the knife cylinder, the method comprising:
preparing the knife cylinder having: a fixing hole opening to the outer circumference face; an active-force generator arranged inside the fixing hole; a sliding member that is freely fitted into the fixing hole and that selectively exerts attracting or resilient force on the active-force generator; and a stopping member that is integrated with the sliding member and that is disposed so as to face the opening of the fixing hole, and the blade mount having a first penetrating hole and a second penetrating hole connected to each other and having different opening diameters,
bringing the blade mount into contact with the outer circumference face of the knife cylinder such that the first penetrating hole having a larger diameter on the blade mount faces the stopping member of the sliding member;
generating resilient force between the active-force generator and the sliding member and thereby projecting the stopping member externally from the outer circumference face of the knife cylinder; and
sliding the blade mount with respect to the outer circumference face of the knife cylinder such that the inner wall of the second penetrating hole having a smaller diameter formed on the blade mount is fitted into the space between the outer circumference of the knife cylinder and the stopping member, so that the blade mount is fixed to the outer circumference face of the knife cylinder.

2. The method according to claim 1, further comprising embedding magnets into at least part of facing surfaces of the active-force generator and the sliding member, the facing surfaces facing each other, to form magnetic regions, wherein
the generating causes the magnetic regions having the same polar of the active-force generator and the sliding member to face each other and thereby generates the resilient force, and
when the sliding member does not fix the blade mount, attractive force is generated between the active-force generator and the sliding member by causing the magnetic regions having different in polar to face each other or by causing one of the magnetic regions and a magnetic body region to face each, so that the stopping member of the sliding member is placed under the outer circumference face of the knife cylinder.

3. The method according to claim 2, further comprising embedding N-polar magnets into part of the facing surfaces of the active-force generator and the sliding member to form N-polar magnetic regions and embedding S-polar magnets into other part of facing surfaces of the active-force generator and the sliding member to form S-polar magnetic regions; wherin
the generating causes the magnetic regions having the same polar of the active-force generator to face each other and the sliding member and thereby generates the resilient force, and
when the sliding member does not fix the blade mount, attractive force is generated between the active-force generator and the sliding member by causing the magnetic regions having different in polar to face each other, so that the stopping member of the sliding member is placed under the outer circumference face of the knife cylinder.

4. The method according to claim 2, further comprising embedding magnets the same in polar into at least part of facing surfaces of the active-force generator and the sliding member, the facing surfaces face each other, to form magnetic regions, and forming magnetic metal regions on different parts of the facing surfaces of the active-force generator and the sliding member, wherein
the generating causes the magnetic regions of the active-force generator and the sliding member to face each other and thereby generates the resilient force, and
when the blade mount is not being fixed, attractive force is generated between the active-force generator and the sliding member by causing each respective magnetic regions and each magnetic body region to face each other, so that the stopping member of the sliding member is placed under the outer circumference face of the knife cylinder.

5. A knife cylinder that faces an anvil cylinder and that has cylindrical outer circumference face that holds the blade mount, and that cuts a sheet-shape article placed into a space between the anvil cylinder and the knife cylinder, the knife cylinder comprising:
a fixing hole opening to the outer circumference face;
an active-force generator arranged inside the fixing hole;
a sliding member that is freely fitted into the fixing hole and that selectively exerts attracting or resilient force on the active-force generator; and
a stopping member that is integrated with the sliding member and that is projected outwardly from the outer circumference face of the knife cylinder when the resilient force is exerted between the sliding member and the active-force generator,
wherein the inner wall of a penetrating hole formed on the blade mount is fitted into the space between the outer circumference of the knife cylinder and the stopping member, so that the blade mount is fixed to the outer circumference face of the knife cylinder.

6. The knife cylinder according to claim 5, further comprising magnetic regions formed on at least part of facing surfaces of the active-force generator and the sliding member, the facing surface facing each other, by embedding magnets, wherein
the sliding member is rotatable around the axis thereof,
resilient force is generated between the active-force generator and the sliding member by causing the magnetic regions the same in polar of the active-force generator and the sliding member to face each other while attracting force is generated between the active-force generator and the sliding member by causing the magnetic regions opposite in polar of the active-force generator and the sliding member to face each other.

7. The knife cylinder according to claim 6, wherein
the active-force generator and the sliding member each comprise an N-polar magnetic region formed by embedding an N-polar magnet on a first region of the facing surface and an S-polar magnetic region formed by embedding an S-polar magnet on a second region of the facing surface;
the sliding member is rotatable around the axis thereof, and
resilient force is generated between the active-force generator and the sliding member by causing the magnetic regions the same in polar of the active-force generator and the sliding member to face each other while attracting force is generated between the active-force generator and the sliding member by causing the magnetic regions opposite in polar of the active-force generator and the sliding member to face each other.

8. The knife cylinder according to claim 6, wherein:
the active-force generator and the sliding member each comprise a magnetic region formed by embedding a magnet same in polar in part of the facing surface and a magnetic metal region on different part of the facing surface;
the sliding member is rotatable around the axis thereof;
resilient force is generated between the active-force generator and the sliding member by causing the magnetic regions of the active-force generator and the sliding member to face each other while attracting force is generated between the active-force generator and the sliding member by causing the respective magnetic regions of the active-force generator and the sliding member to face the respective magnetic metal regions, so that the stopping member of the sliding member is placed under the outer circumference face of the knife cylinder.

9. The knife cylinder according to claim 5, further comprising a spring member that is disposed between the active-force generator and the sliding member and that generates auxiliary urging force to the resilient force between the active-force generator and the sliding member.

10. A rotary die cutter comprising an anvil cylinder and a knife cylinder facing each other, the knife cylinder having an outer circumference face holding a blade mount, the rotary die cutter inserting a sheet-shaped article between the anvil cylinder and the knife cylinder and cutting the sheet-shaped article, wherein:
the knife cylinder is defined in claim 5; and
the inner wall of a penetrating hole formed on the blade mount is fitted into a space between the outer circumference face of the knife cylinder and the stopping member so that the blade mount is fixed to the outer circumference face of the knife cylinder.

11. A blade mount that is fixed to the outer circumference face of a knife cylinder and that cuts a sheet-shaped article placed between an anvil cylinder and the knife cylinder, the blade mount comprising:
a first penetrating hole having a larger diameter than that of a stopping member projecting from the outer circumference face of the knife cylinder and a second penetrating hole having a smaller diameter than that of the stopping member, the first penetrating hole being connected to the second penetrating hole, wherein
the blade mount is brought into contact with the outer circumference face of the knife cylinder to allow the stopping member to be inserted and placed into the first penetrating hole, and
the inner wall of the second penetrating hole is fitted into and fixed to the space between the stopping member and the outer circumference face of the knife cylinder.

12. The blade mount according to claim 11, wherein
the inner wall of the second wall is a slope wall having a slope face widening toward the outer face, and
the slope wall is fitted into and fixed to the space between the stopping member and the outer circumference face of the knife cylinder.
